(19) United States
(12) Patent Application Publication
(10) Pub. No.: US 2025/0355862 A1
(43) Pub. Date: Nov. 20, 2025

(54) DATA CONSISTENCY SERVICE FOR INTERNAL AND EXTERNAL VOLUMES

(71) Applicant: Snowflake Inc., Bozeman, MT (US)

(72) Inventors: Vamsi Krishna Bokam, Bellevue, WA (US); Vlad Bunescu, Morgan Hill, CA (US); Pallavi Kakunje, San Jose, CA (US); Nithin Mahesh, Kirkland, WA (US); Marianne Shaw, Bothell, WA (US); Yantao Song, Sammamish, WA (US); Zerui Wei, San Mateo, CA (US); Aihua Xu, San Jose, CA (US); Jiaqi Yan, Menlo Park, CA (US)

(21) Appl. No.: 18/807,020

(22) Filed: Aug. 16, 2024

Related U.S. Application Data
(60) Provisional application No. 63/648,072, filed on May 15, 2024.

(51) Int. Cl. G06F 16/23; G06F 11/07; G06F 16/2453

(52) U.S. Cl. CPC G06F 16/2365; G06F 16/2358; G06F 16/24542

(57) ABSTRACT

A network-based database system that performs consistency checks on data files to which the network-based database system does not have write access is provided. The network-based database system monitors a data file stored in a read-only storage system for changes. Upon detecting a change, the network-based database system performs a data consistency check using the content of the data file and its first metadata. If an inconsistency between the content and the first metadata is detected, the network-based database system sets a flag in second metadata, which is stored in a writable storage system, indicating the detected inconsistency. The network-based database system detects this flag during the execution of a query against a data object of the data file and executes the query without query performance tuning based on the detection of the flag, ensuring accurate query results.

### PRIORITY CLAIM

This application claims the benefit of priority to U.S. Provisional Patent Application Ser. No. 63/648,072, filed May 15, 2024, the contents of which are incorporated herein by reference.

### TECHNICAL FIELD

Examples of the disclosure relate generally to a network-based database system or a cloud data platform and, more specifically, to data consistency determinations.

### BACKGROUND

Cloud-based network-based databases and other database systems or data platforms sometimes provide support for performing operations on external data. Such external data may be in a different table format or different file format.

### BRIEF DESCRIPTION OF THE DRAWINGS

The present disclosure will be understood more fully from the detailed description given below and from the accompanying drawings of various examples of the disclosure.

FIG. 1 illustrates an example computing environment that includes a network-based database system in communication with a cloud storage provider system, according to some examples.

FIG. 2 is a diagram illustrating an external volume object within the network-based database system, according to some examples.

FIG. 3 illustrates an example of a processing flow and example structure for storing data in an external volume and an internal volume, according to some examples.

FIG. 4 illustrates a consistency check method, according to some examples.

FIG. 5 illustrates a method for scanning structured data objects, according to some examples.

FIG. 6 is a block diagram illustrating components of an execution platform, according to some examples.

FIG. 7 illustrates a diagrammatic representation of a machine in the form of a computer system within which a set of instructions may be executed for causing the machine to perform any one or more of the methodologies discussed herein, according to some examples.

### DETAILED DESCRIPTION

Data platforms, which may be structured as on-premises or network-based systems like cloud-based data platforms, are utilized for a wide array of data storage and access operations. These platforms can support various data processing types, including Online Transactional Processing (OLTP), Online Analytical Processing (OLAP), or a combination thereof, and may comprise relational database management systems (RDBMS) or other database management systems.

Historically, database systems primarily dealt with data stored internally, where they had full control over data formats and consistency checks. However, modern business requirements include the integration of external data sources, which often do not conform to the internal data governance and structure of traditional database systems. These external data sources can include third-party data services, cloud storage solutions, and on-premises data repositories, each potentially utilizing different data schemas and storage formats.

The introduction of structured data types and complex data objects in database systems further complicates data consistency checks. Traditional methods of data validation and error detection are often not equipped to handle the complexity and scale of modern data architectures, leading to potential data integrity issues that can propagate errors across business processes.

Moreover, the shift towards real-time data processing and the need for immediate data availability have made it useful for database systems to not only detect but also ameliorate the effects of inconsistencies in a timely manner. Such a process uses sophisticated mechanisms that can perform deep data inspections without compromising system performance.

Given these challenges, there is a need for advanced data consistency services that operate efficiently within network-based database systems. These services should be capable of handling various data types and formats, ensuring robust data validation, error detection, and correction across both internal and external data volumes. The development of such services represents a significant advancement in the field of database technology, addressing the pressing demands for data accuracy and reliability in an increasingly data-centric world.

In some examples, a network-based database system monitors a data file for changes, where the data file is stored in a read-only storage system. Upon detecting a change, the network-based database system performs a data consistency check using the content of the data file and its metadata. If an inconsistency between the content and the metadata is detected, a flag is set in additional metadata stored in a writable storage system, indicating the detected inconsistency.

In some examples, the network-based database system detects the flag during the execution of a query against a data object of the data file and executes the query without query performance tuning based on the detected flag.

In some examples, the network-based database system generates a report detailing the detected inconsistencies between the content of the data file and the first metadata. This report aids in understanding the nature and extent of the inconsistencies, facilitating targeted corrective actions.

In some examples, the data file comprises structured data types, and the data consistency check includes validating each structured data type against corresponding metadata. This ensures that each data type is correctly stored and maintained according to its defined structure and constraints.

In some examples, the data consistency check is performed periodically based on a predefined schedule. This regular checking helps in maintaining ongoing data integrity and promptly addressing any arising issues.

In some examples, the network-based database system notifies a user via a user interface about the detected inconsistency and the setting of the flag. This notification process keeps relevant stakeholders informed about the data integrity status and any actions needed.

In some examples, the flag is stored in a distributed metadata system that is accessible by multiple computing nodes performing queries against the data file. This distributed approach ensures that all nodes involved in data processing are aware of the current data integrity status and can adjust their operations accordingly.

In some examples, the data file is stored in a cloud-based storage system, and the network-based database system transmits the flag to a cloud-based metadata management service. This service helps in managing the metadata centrally, providing a cohesive view of data integrity across the cloud storage.

In some examples, the network-based database system logs the detected inconsistency in an audit log for compliance and monitoring purposes. This logging is useful for traceability, regulatory compliance, and historical analysis of data integrity issues.

In some examples, executing the query without query performance tuning involves bypassing a query performance tuning engine configured to use the first metadata for optimizing query execution. This ensures that the query results are accurate and not based on potentially corrupted metadata.

In some examples, upon determining that the inconsistency has been resolved, the network-based database system removes the flag from the second metadata. This removal signifies that the data file has returned to a state of integrity and the metadata is once again reliable for use in data processing and query performance tuning.

Reference will now be made in detail to specific examples for carrying out the inventive subject matter. Examples of these specific examples are illustrated in the accompanying drawings, and specific details are set forth in the following description in order to provide a thorough understanding of the subject matter. It will be understood that these examples are not intended to limit the scope of the claims to the illustrated examples. On the contrary, they are intended to cover such alternatives, modifications, and equivalents as may be included within the scope of the disclosure.

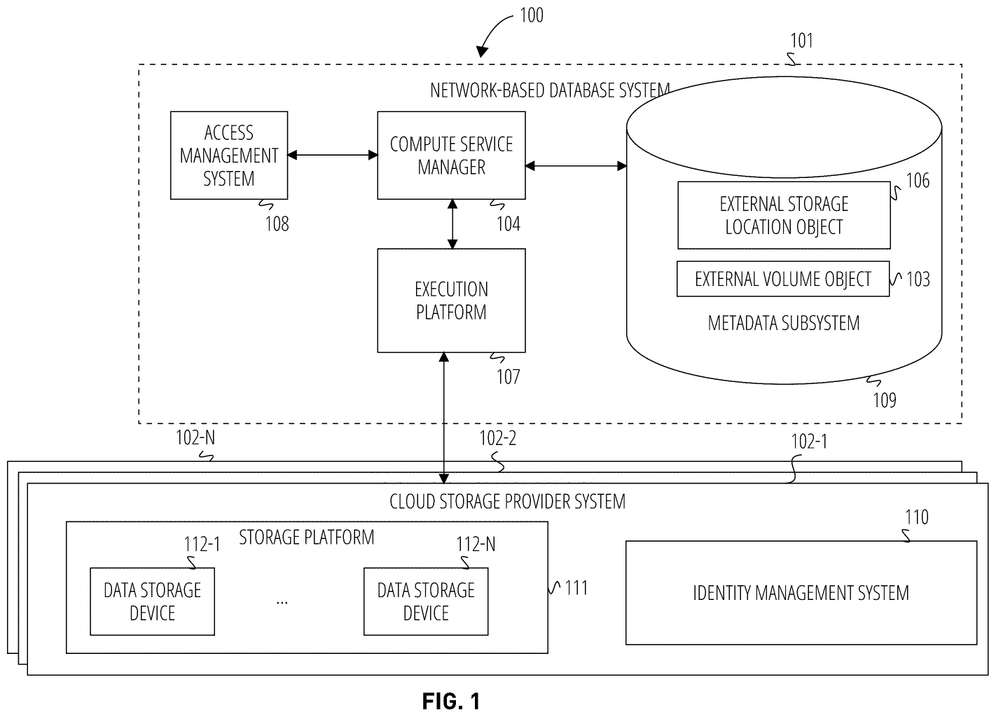

FIG. 1 illustrates a computing environment 100 that includes a network-based database system 101 in communication with at least one of a cloud storage provider system (e.g., cloud storage provider system 102-1, cloud storage provider system 102-2, cloud storage provider system 102-N), according to some examples. A skilled artisan will readily recognize that various additional functional components may be included as part of the computing environment 100 to facilitate additional functionality that is not specifically described herein.

As noted above, external storage locations are used in network-based database systems to load data to and unload data from customer-managed storage locations, and conventional external storage locations are provided with secret security credentials to enable access to these storage locations, which can create security vulnerabilities for the data. Aspects of the present disclosure address the above and other deficiencies of prior database functionality by creating credential-less external storage location objects that do not require users to share secret security credentials with a network-based database system 101 to facilitate loading and unloading of data at storage locations in external cloud storage provider systems. The credential-less external state objects described herein also allow client account administrators to prevent data exfiltration through fine-grained control of access permissions.

Consistent with some examples, network-based database system 101 creates an integration object comprising an identifier of a storage location (e.g., a universal resource locator (URL)) in a storage platform of an external cloud storage provider system (e.g., Amazon Web Services® (AWS), Microsoft Azure Blob Storage®, or Google Cloud Storage) to which the network-based database system 101 is to be provided access to load and unload data. The integration object further comprises an identifier of a proxy identity object maintained by the external cloud storage provider system. Once created, the network-based database system 101 associates the integration object with a cloud identity object that the cloud storage provider system associates with the proxy identity object. The proxy identity object defines a proxy identity that is granted access to the storage location and may be assumed by the cloud identity object to load and unload data at the storage location.

The network-based database system 101 creates the integration object based on a command to create the storage integration. The command can be provided, for example, by an administrative user of a client account of the network-based database system 101. The cloud identity object that is associated with the integration object corresponds to the client account to which the user belongs. A storage integration definition comprises the identifier of the storage location, the identifier of the proxy identity object, and an identifier of the cloud storage provider system. The storage integration definition can, in some instances, further specify one or more storage locations to which access is permitted or denied. The storage definition object can specify certain segments within the storage location to which access is denied. For example, the storage location can be identified by a file path that corresponds to a storage resource within the storage platform such as a bucket or folder, and the command may specify a sub-folder within the file path to which access is denied. In another example, the command may specify one or more file paths to which access is permitted and in this example, access to all other file paths will be denied by default.

The network-based database system 101 creates an external storage location object based on the storage integration object to load or unload data at the storage location. The external storage location object comprises the identifier of the storage location and an identifier of the storage integration object. The network-based database system 101 creates the external storage location object based on a command to create the external storage location object provided, for example, by the user that provided the storage integration definition.

The network-based database system 101 can receive a command to load or unload data at the storage location. The command comprises an identifier of the external storage location object. In response to the command, the network-based database system 101 utilizes the external storage location object to load or unload data at the storage location in the storage platform of the external cloud storage provider. In doing so, the network-based database system 101 uses security credentials associated with the cloud identity object to access credentials to allow the cloud identity object to assume the proxy identity to load or unload the data. In this manner, the external storage location object enables data to be loaded or unloaded at the storage location without exchanging security credentials associated with the storage location or storing the security credentials associated with the storage location with network-based database system 101 system.

Credential-less external storage location objects, as described herein, separate the process of giving permissions to a storage location from the usage of that storage location to load and unload data. Credential-less external storage location objects also allow organizations to give permissions to a network-based database system 101 to use their data locations instead of giving secret credentials to the network-based database system 101. Organizations can specify what roles may create and use storage locations for access separately from who may create and use storage locations set up in advance. For instance, an organization may allow account administrators to create a connection to a storage location and because only the account administrators can create storage integrations, additional storage integrations cannot be created to export data to thereby prevent confidential data exfiltration to unknown locations. Once created, non-administrative users can be granted permissions to read and write from fixed storage locations into an external storage location object they create. A lower privilege user may only have the ability to use an existing storage location.

Users with permissions to create a storage integration can control what paths under a base location can be accessed using that integration. Giving account administrators the ability to specify which users may create and use storage integrations allow an organization to control where their internal data may flow to, or completely lock down data export altogether.

External credential-less storage location objects also provide the benefit of allowing access permissions to storage to be managed by the cloud storage provider thereby allowing organizations utilizing the network-based database system 101 to leverage from their storage provider to manage data access by the network-based database system 101. If an account administrator decides to revoke access by the network-based database system 101 to a storage location, it can be done immediately using the access controls provided by the storage provider.

As shown, the computing environment 100 comprises the network-based database system 101 and one or more cloud storage provider systems (e.g., AWS®, Microsoft Azure Blob Storage®, or Google Cloud Storage) corresponding to cloud storage provider system 102-1, cloud storage provider system 102-2, and cloud storage provider system 102-N. The network-based database system 101 is a network-based system used for reporting and analysis of integrated data from one or more disparate sources including one or more storage locations within the cloud storage provider system 102-1. The cloud storage provider system 102-1 comprises a plurality of computing machines and provides on-demand computer system resources such as data storage and computing power to the network-based database system 101.

The network-based database system 101 comprises an access management system 108, a compute service manager 104, an execution platform 107, and a metadata subsystem 109. In some examples, the metadata subsystem 109 includes a datastore, a database, caching services, and the like. The network-based database system 101 hosts and provides data reporting and analysis services to multiple client accounts. The access management system 108 enables administrative users of client accounts to manage access to resources and services provided by the network-based database system 101. Administrative users can create and manage identities (e.g., users, roles, and groups) and use permissions to allow or deny access to the identities to resources and services.

The compute service manager 104 coordinates and manages operations of the network-based database system 101. The compute service manager 104 also performs query performance tuning and compilation as well as managing clusters of computing services that provide compute resources (also referred to as “virtual warehouses”). The compute service manager 104 can support any number of client accounts such as end users providing data storage and retrieval requests, system administrators managing the systems and methods described herein, and other components/devices that interact with compute service manager 104.

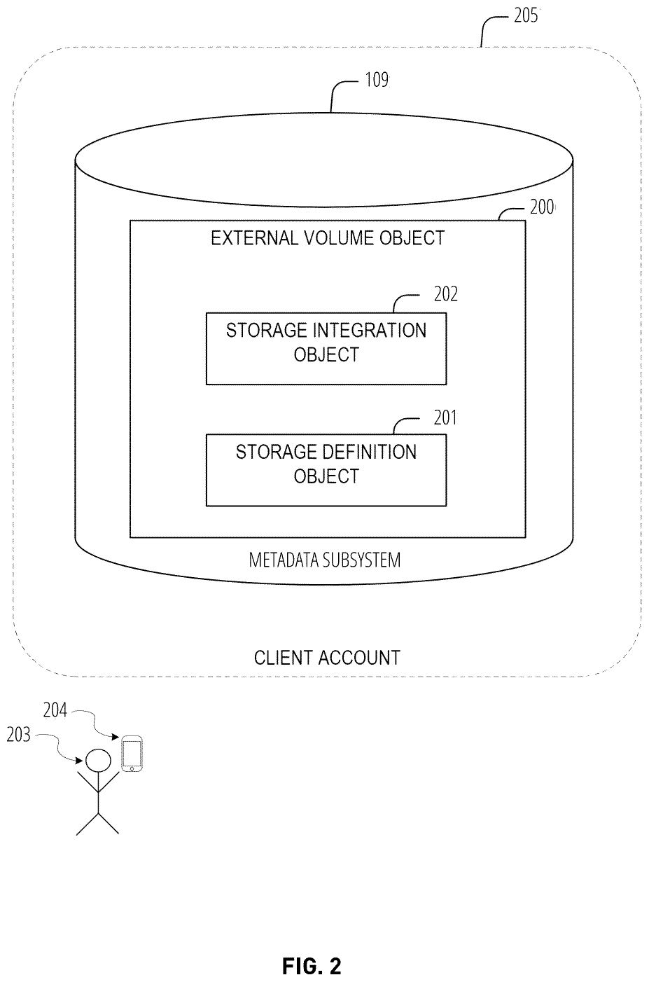

The compute service manager 104 is also coupled to metadata subsystem 109, which is associated with the data stored in the computing environment 100. The metadata subsystem 109 stores data pertaining to various functions and aspects associated with the network-based database system 101 and its users. For example, the metadata subsystem 109 stores one or more external volume objects 103 and one or more credential-less external storage location objects 106. An example of an external volume object is discussed in more detail in FIG. 2 below and enables access to an external volume as provided by examples of the subject system discussed herein.

In general, an external storage location object 106 specifies a storage location (e.g., a URL) where data files are stored so that the data in the files can be loaded into an internal map cached within the compute nodes by the network-based database system 101 or so that data from a table can be unloaded into the data files stored internally by the network-based database system 101. The one or more credential-less external storage location object 106 enable the network-based database system 101 to access storage locations within the cloud storage provider system 102-1 without storing, using, or otherwise accessing security credentials associated with the storage locations.

In some examples, the metadata subsystem 109 includes a summary of data stored in remote data storage systems as well as data available from a local cache. Additionally, the metadata subsystem 109 may include information regarding how data is organized in remote data storage systems (e.g., the cloud storage provider system 102-1) and the local caches. The metadata subsystem 109 allows systems and services to determine whether a piece of data needs to be accessed without loading or accessing the actual data from a storage device.

The compute service manager 104 is further coupled to the execution platform 107, which provides multiple computing resources that execute various data storage and data retrieval tasks. The execution platform 107 is coupled to storage platform 111 of the cloud storage provider system 102-1. The storage platform 111 comprises multiple data storage devices 112-1 to 112-N, and each other storage platform can also include multiple data storage devices. In some examples, the data storage devices 112-1 to 124-N are cloud-based storage devices located in one or more geographic locations. For example, the data storage devices 112-1 to 124-N may be part of a public cloud infrastructure or a private cloud infrastructure. The data storage devices 112-1 to 124-N may be hard disk drives (HDDs), solid state drives (SSDs), storage clusters, Amazon S3™ storage systems or any other data storage technology. Additionally, the cloud storage provider system 102-1 may include distributed file systems (such as Hadoop Distributed File Systems (HDFS)), object storage systems, and the like. Similarly, any of the data storage devices in other cloud storage provider systems as discussed further herein can also have similar characteristics described above in connection with cloud storage provider system 102-1.

The execution platform 107 comprises a plurality of compute nodes. A set of processes on a compute node executes a query plan compiled by the compute service manager 104. The set of processes can include: a first process to execute the query plan; a second process to monitor and delete micro-partition files using a least recently used (LRU) policy and implement an out of memory (OOM) error mitigation process; a third process that extracts health information from process logs and status to send back to the compute service manager 104; a fourth process to establish communication with the compute service manager 104 after a system boot; and a fifth process to handle all communication with a compute cluster for a given job provided by the compute service manager 104 and to communicate information back to the compute service manager 104 and other compute nodes of the execution platform 107.

In addition to the storage platform 111, the cloud storage provider system 102-1 also comprises an authentication and identity management system 110. The authentication and identity management system 110 allows users to create and manage identities (e.g., users, roles, and groups) and use permissions to allow or deny access of the identities to cloud services and resources. The access management system 108 of the network-based database system 101 and the authentication and identity management system 110 of the cloud storage provider system 102-1 can communicate and share information so as to enable access and management of resources and services shared by users of both the network-based database system 101 and the cloud storage provider system 102-1.

In some examples, communication links between elements of the computing environment 100 are implemented via one or more data communication networks. These data communication networks may utilize any communication protocol and any type of communication medium. In some examples, the data communication networks are a combination of two or more data communication networks (or sub-networks) coupled to one another. In alternate examples, these communication links are implemented using any type of communication medium and any communication protocol.

As shown in FIG. 1, the data storage devices 112-1 to 124-N are decoupled from the computing resources associated with the execution platform 107. This architecture supports dynamic changes to the network-based database system 101 based on the changing data storage/retrieval needs as well as the changing needs of the users and systems. The support of dynamic changes allows the network-based database system 101 to scale quickly in response to changing demands on the systems and components within the network-based database system 101. The decoupling of the computing resources from the data storage devices supports the storage of large amounts of data without requiring a corresponding large amount of computing resources. Similarly, this decoupling of resources supports a significant increase in the computing resources utilized at a particular time without requiring a corresponding increase in the available data storage resources.

The compute service manager 104, metadata subsystem 109, execution platform 107, storage platform 111, and authentication and identity management system 110 are shown in FIG. 1 as individual discrete components. However, each of the compute service manager 104, metadata subsystem 109, execution platform 107, storage platform 111, and authentication and identity management system 110 may be implemented as a distributed system (e.g., distributed across multiple systems/platforms at multiple geographic locations). Additionally, each of the compute service manager 104, metadata subsystem 109, execution platform 107, storage platform 111, and authentication and identity management system 110 can be scaled up or down (independently of one another) depending on changes to the requests received and the changing needs of the network-based database system 101. Thus, in the described examples, the network-based database system 101 is dynamic and supports regular changes to meet the current data processing needs.

During typical operation, the network-based database system 101 processes multiple jobs determined by the compute service manager 104. These jobs are scheduled and managed by the compute service manager 104 to determine when and how to execute the job. For example, the compute service manager 104 may divide the job into multiple discrete tasks and may determine what data is needed to execute each of the multiple discrete tasks. The compute service manager 104 may assign each of the multiple discrete tasks to one or more nodes of the execution platform 107 to process the task. The compute service manager 104 may determine what data is needed to process a task and further determine which nodes within the execution platform 107 are best suited to process the task. Some nodes may have already cached the data needed to process the task and, therefore, be a good candidate for processing the task. Metadata stored in the metadata subsystem 109 assists the compute service manager 104 in determining which nodes in the execution platform 107 have already cached at least a portion of the data needed to process the task. One or more nodes in the execution platform 107 process the task using data cached by the nodes and, if necessary, data retrieved from the cloud storage provider system 102-1. It is desirable to retrieve as much data as possible from caches within the execution platform 107 because the retrieval speed is typically much faster than retrieving data from the cloud storage provider system 102-1.

In examples, the compute service manager 104 is also coupled to one or more metadata databases that store metadata pertaining to various functions and aspects associated with the network-based database system 101 and its users. In some examples, a data structure can be utilized for storage of database metadata in the metadata database. For example, such a data structure may be generated from metadata micro-partitions and may be stored in a metadata cache memory. The data structure includes table metadata pertaining to database data stored across a table of the database. The table may include multiple micro-partitions serving as immutable storage devices that cannot be updated in-place. Each of the multiple micro-partitions can include numerous rows and columns making up cells of database data. The table metadata may include a table identification and versioning information indicating, for example, how many versions of the table have been generated over a time period, which version of the table includes the most up-to-date information, how the table was changed over time, and so forth. A new table version may be generated each time a transaction is executed on the table, where the transaction may include a DML statement such as an insert, delete, merge, and/or update command. Each time a DML statement is executed on the table, and a new table version is generated, one or more new micro-partitions may be generated that reflect the DML statement.

In some examples, the aforementioned table metadata includes global information about the table of a specific version. The aforementioned data structure further includes file metadata that includes metadata about a micro-partition of the table. The terms “file” and “micro-partition” may each refer to a subset of database data and may be used interchangeably. In some examples. The file metadata includes information about a micro-partition of the table. Further, metadata may be stored for each column of each micro-partition of the table. The metadata pertaining to a column of a micro-partition may be referred to as an Expression Property (EP) and may include any suitable information about the column, including for example, a minimum and maximum for the data stored in the column, a type of data stored in the column, a subject of the data stored in the column, versioning information for the data stored in the column, file statistics for all micro-partitions in the table, global cumulative expressions for columns of the table, and so forth. Each column of each micro-partition of the table may include one or more expression properties. It should be appreciated that the table may include any number of micro-partitions, and each micro-partition may include any number of columns. The micro-partitions may have the same or different columns and may have different types of columns storing different information. As discussed further herein, the subject technology provides a file system that includes “EP” files (expression property files), where each of the EP files stores a collection of expression properties about corresponding data. As described further herein, each EP file (or the EP files, collectively) can function similar to an indexing structure for micro-partition metadata. Stated another way, each EP file contains a “region” of micro-partitions, and the EP files are the basis for persistence, cache organization and organizing the multi-level structures of a given table's EP metadata. Additionally, in some implementations of the subject technology, a two-level data structure (also referred to as “2-level EP” or a “2-level EP file”) can at least store metadata corresponding to grouping expression properties and micro-partition statistics.

As mentioned above, a table of a database may include many rows and columns of data. One table may include millions of rows of data and may be very large and difficult to store or read. A very large table may be divided into multiple smaller files corresponding to micro-partitions. For example, one table may be divided into six distinct micro-partitions, and each of the six micro-partitions may include a portion of the data in the table. Dividing the table data into multiple micro-partitions helps to organize the data and to find where certain data is located within the table.

In some examples, all data in tables is automatically divided into an immutable storage device referred to as a micro-partition. The micro-partition may be considered a batch unit where each micro-partition has contiguous units of storage. By way of example, each micro-partition may contain between 50 MB and 500 MB of uncompressed data (note that the actual size in storage may be smaller because data may be stored compressed).

Groups of rows in tables may be mapped into individual micro-partitions organized in a columnar fashion. This size and structure allow for extremely granular selection of the micro-partitions to be scanned, which can be composed of millions, or even hundreds of millions, of micro-partitions. This granular selection process may be referred to herein as “pruning” based on metadata.

In an example, pruning involves using metadata to determine which portions of a table, including which micro-partitions or micro-partition groupings in the table, are not pertinent to a query, and then avoiding those non-pertinent micro-partitions (e.g., files) and micro-partition groupings (e.g., regions) when responding to the query and scanning only the pertinent micro-partitions to respond to the query. Metadata may be automatically gathered about all rows stored in a micro-partition, including: the range of values for each of the columns in the micro-partition; the number of distinct values; and/or additional properties used for both query performance tuning and efficient query processing. In some examples, micro-partitioning may be automatically performed on all tables. For example, tables may be transparently partitioned using the ordering that occurs when the data is inserted/loaded.

The micro-partitions as described herein can provide considerable benefits for managing database data, finding database data, and organizing database data. Each micro-partition organizes database data into rows and columns and stores a portion of the data associated with a table. One table may have many micro-partitions. The partitioning of the database data among the many micro-partitions may be done in any manner that makes sense for that type of data.

A query may be executed on a database table to find certain information within the table. To respond to the query, a compute service manager 104 scans the table to find the information requested by the query. The table may include millions and millions of rows, and it would be very time consuming and it would require significant computing resources for the compute service manager 104 to scan the entire table. The micro-partition organization along with the systems, methods, and devices for database metadata storage of the subject technology provide significant benefits by at least shortening the query response time and reducing the amount of computing resources that are required for responding to the query.

The compute service manager 104 may find the cells of database data by scanning database metadata. The multiple level database metadata of the subject technology enables the compute service manager 104 to quickly and efficiently find the correct data to respond to the query. The compute service manager 104 may find the correct table by scanning table metadata across all the multiple tables in a given database. The compute service manager 104 may find a correct grouping of micro-partitions by scanning multiple grouping expression properties across the identified table. Such grouping expression properties include information about database data stored in each of the micro-partitions within the grouping.

The compute service manager 104 may find a correct micro-partition by scanning multiple micro-partition expression properties within the identified grouping of micro-partitions. The compute service manager 104 may find a correct column by scanning one or more column expression properties within the identified micro-partition. The compute service manager 104 may find the correct row(s) by scanning the identified column within the identified micro-partition. The compute service manager 104 may scan the grouping expression properties to find groupings that have data based on the query. The compute service manager 104 reads the micro-partition expression properties for that grouping to find one or more individual micro-partitions based on the query. The compute service manager 104 reads column expression properties within each of the identified individual micro-partitions. The compute service manager 104 scans the identified columns to find the applicable rows based on the query.

In some examples, an expression property is information about the one or more columns stored within one or more micro-partitions. For example, multiple expression properties are stored that each pertain to a single column of a single micro-partition. In some examples, one or more expression properties are stored that pertain to multiple columns and/or multiple micro-partitions and/or multiple tables. The expression property is any suitable information about the database data and/or the database itself. In some examples, the expression property includes one or more of: a summary of database data stored in a column, a type of database data stored in a column, a minimum and maximum for database data stored in a column, a null count for database data stored in a column, a distinct count for database data stored in a column, a structural or architectural indication of how data is stored, and the like. It is appreciated that a given expression property is not limited to a single column, and can also be applied to a predicate. In addition, an expression property can be derived from a base expression property of all involving columns.

In some examples, the metadata organization structures of the subject technology may be applied to database “pruning” based on the metadata as described further herein. The metadata organization may lead to extremely granular selection of pertinent micro-partitions of a table. Pruning based on metadata is executed to determine which portions of a table of a database include data that is relevant to a query. Pruning is used to determine which micro-partitions or groupings of micro-partitions are relevant to the query, and then scanning only those relevant micro-partitions and avoiding all other non-relevant micro-partitions. By pruning the table based on the metadata, the subject system can save significant time and resources by avoiding all non-relevant micro-partitions when responding to the query. After pruning, the system scans the relevant micro-partitions based on the query.

In some examples, the metadata subsystem 109 includes EP files (expression property files), where each of the EP files store a collection of expression properties about corresponding data. As mentioned before, EP files provide a similar function to an indexing structure into micro-partition metadata. Metadata may be stored for each column of each micro-partition of a given table. In some examples, the aforementioned EP files can be stored in a cache provided by the subject system for such EP files (e.g., “EP cache”).

As shown in FIG. 1, the computing environment 100 separates the execution platform 107 from the storage platform 111. In this arrangement, the processing resources and cache resources in the execution platform 107 operate independently of the data storage devices 112-1 to 124-n in the cloud storage provider system 102-1. Thus, the computing resources and cache resources are not restricted to specific data storage devices 112-1 to 124-n. Instead, all computing resources and all cache resources may retrieve data from, and store data to, any of the data storage resources in the cloud storage provider system 102-1.

FIG. 2 is a data flow diagram illustrating use of an external volume object 200 within the computing environment 100, according to some examples. The external volume object 200 is an example of the external volume object 103 illustrated in FIG. 1. The external volume object 200 is generated by the compute service manager 104 and stored in the metadata subsystem 109. The external volume object 200 is generated by the compute service manager 104 within a client account 205. The compute service manager 104 creates the external volume object 200 based on input received from a computing device in communication with the network-based database system 101. For example, a user 203 of the client account 205 can utilize a command line or other user interface provided to a computing device 204 by the network-based database system 101 to provide a command to create the external volume object 200. The external volume object 200 includes a storage definition object 201 and also encapsulates (e.g., includes) a storage integration object 202. In an implementation, as part of creating the external volume object, the storage definition object 201 and storage integration object 202 are created within the client account 205 by the compute service manager 104 and is stored within the metadata subsystem 109.

In an implementation, the storage definition object 201 is a component used to load or unload data at a storage location within the storage platform 111 to the network-based database system 101. In this particular example, the storage definition object 201 specifies a storage location corresponding to a storage resource within the storage platform 111 as a location from which data can be loaded or unloaded. The storage resource resides on one or more of the storage devices 112-1 to 112-N of the storage platform 111.

The storage integration object 202 defines a storage integration between the network-based database system 101 and an externally managed storage location in the storage platform 111. More specifically, the storage integration object 202 describes properties of a storage integration between the network-based database system 101 and the customer managed storage resource (e.g., a folder, data bucket, or other storage resource). The storage integration object 202 includes an identifier of a storage location corresponding to the storage resource (e.g., a URL) and an identifier of the cloud storage provider system 102-1. In some examples, the storage integration object 202 may further specify one or more storage locations to which access to data is to be denied. For example, the external volume object 200 may identify a base storage location to which access is to be allowed using a file path and the storage integration object 202 may further identify a portion of the base storage location to which access is to be allowed or denied with a sub-path of the file path.

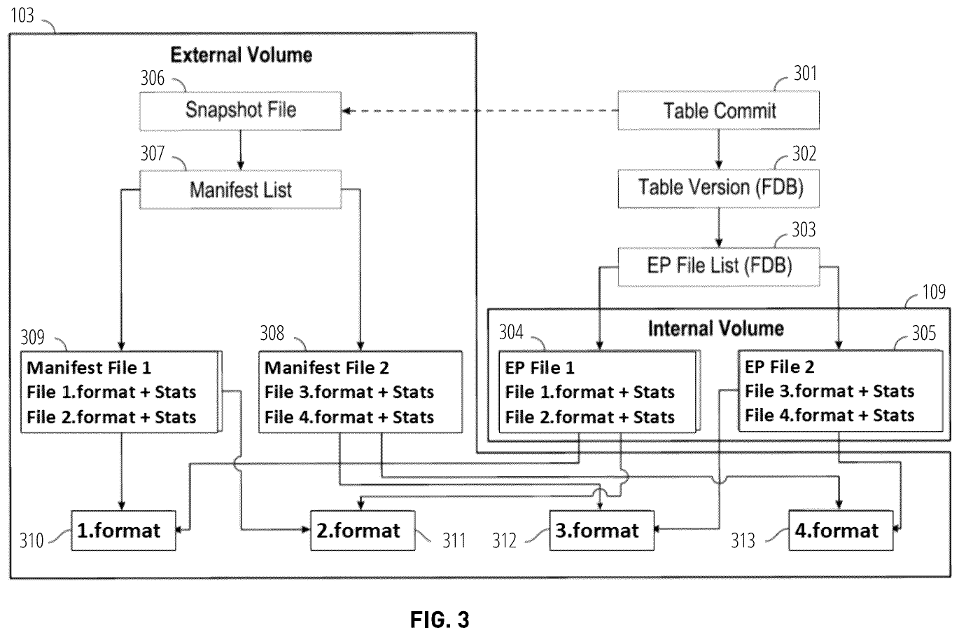

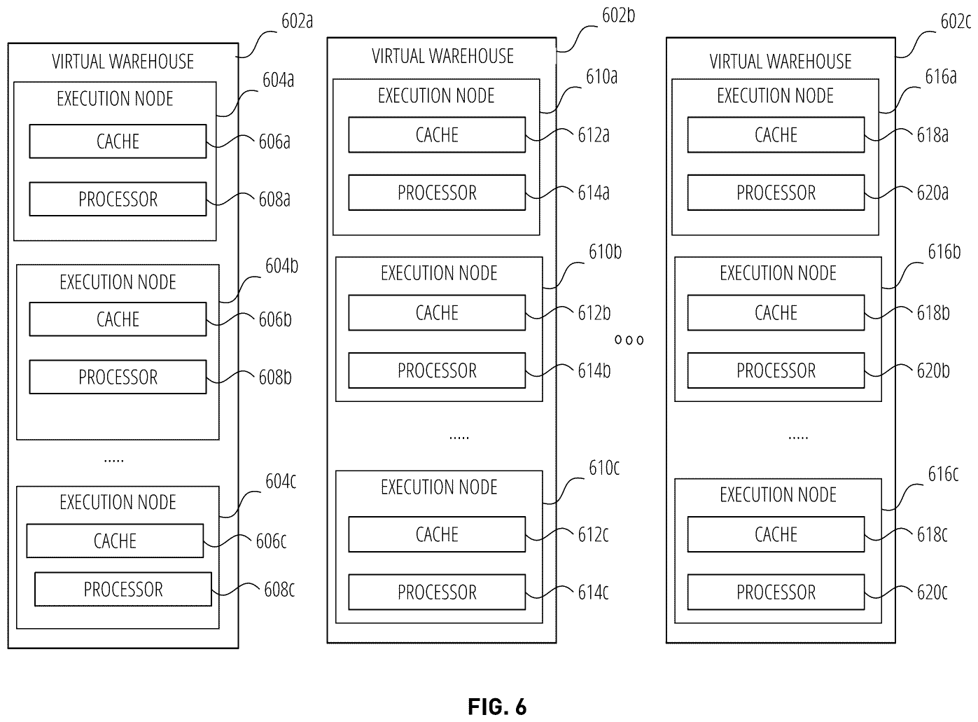

FIG. 3 illustrates an example of a processing flow and example structure for storing data in an external volume and an internal volume, according to some examples. In an implementation, the operations described in FIG. 3 can be performed by components of the network-based database system 101 (e.g., compute service manager 104, a particular execution node such as one described in FIG. 6), and involving a metadata database (e.g., metadata subsystem 109) and a particular storage platform provided by a cloud storage provider system (e.g., storage platform 111 on cloud storage provider system 102-1).

As shown, compute service manager 104 receives a command 301 to commit a table (e.g., as part of a transaction performing a set of statements on the table such as updating or modifying data in the table).

The compute service manager 104 creates a table version 302 corresponding to a snapshot of a new version of the table that is to be committed. In an implementation, table version 302 is stored in internal storage (e.g., metadata subsystem 109) that can be referred to as an “internal volume” for the purposes of discussion and to distinguish against an external volume shown in FIG. 3. An internal volume as shown can store and process metadata in a different manner(s) than metadata stored and processed on an external volume. In an example, a snapshot is an up-to-date representation of data in the table at a point in time. In particular, a snapshot includes a list of data files that make up the table's contents at the time of the snapshot. In an example, data files are stored across multiple manifest files, and the manifest files for a snapshot are listed in a single manifest list.

The compute service manager 104 creates an EP file list 303 corresponding to a set of EP metadata files, which is stored on internal storage (e.g., metadata subsystem 109) in an implementation.

The compute service manager 104 creates a set of EP files including EP file 304 and EP file 305 based on the EP file list 303, which is stored on internal storage (e.g., metadata subsystem 109) in an implementation. In some examples, EP file list 303 can be an EP file data persistence object. As shown, each EP file can include information indicating a set of data files stored in a different file format and associated statistics of each data file in an external volume. As further shown, each EP file includes a reference (e.g., pointer) to a data file stored on the external volume where the data file is in a different file format than utilized for internal storage. In some examples, any appropriate file format may be used to store the data files including, but not limited to, Parquet, CSV, XML, ORC, Avro, JSON, and the like.

In some examples, the compute service manager 104 compacts the set of EP files into combined EP files, including EP file 304 and EP file 305 for operational efficiency as some systems may perform better with combined files.

Turning now to the external volume on storage platform 111, the compute service manager 104 creates a snapshot file 306 in response to the command 301 to commit the table. In some examples, snapshot file 306 is based on a table format that is different from the table format used for table version 302 in internal storage. In some examples, compute service manager 104 can perform the processing flow on the right side of FIG. 3 involving internal storage, and then perform the processing flow on the left side of FIG. 3. In some examples, a compute service manager 104 (of FIG. 1) performs the respective processing flows in parallel.

File formats that are suitable for supporting an appropriate table format include, but are not limited to, Iceberg, Apache Hive ACID, Apache Hudi, and the like.

The compute service manager 104 creates a manifest list 307 which is a list of metadata files stored in accordance with an external table format. In an implementation, information related to a path for each metadata file and associated statistics (e.g., partition statistics, data file counts, and the like) are also included in manifest list 307.

In some examples, a manifest list is a list of manifest files for a snapshot of a given table. A new manifest list is written for each attempt to commit a snapshot of the table in an example. Further, the manifest list includes metadata that can be utilized to avoid scanning all of the manifest files of a snapshot when planning a table scan. For example, such metadata includes a number of added, existing, and deleted files. More specifically, examples of metadata included in a manifest list are the following:
Location of the manifest file
Length of the manifest file in bytes
The type of files tracked by the manifest file.

The sequence number when the manifest files was added to the table
The minimum data sequence number of all live data or delete files in the manifest file
ID of the snapshot where the manifest file was added
Number of entries in the manifest file that have status ADDED
Number of entries in the manifest file that have status EXISTING
Number of entries in the manifest file that have status DELETED
Number of rows in all of files in the manifest file that have status ADDED
Number of rows in all of files in the manifest file that have status EXISTING
Number of rows in all of files in the manifest file that have status DELETED
Implementation-specific key metadata for encryption

In an implementation, a manifest file is a metadata file that lists a subset of data files that make up a snapshot. In an implementation, information for each data file in a manifest file includes information such as column-level statistics, and summary information that can be utilized for pruning during query plan compilation. More specifically, examples of metadata included in a manifest file can include the following:
JSON representation of the table schema at the time the manifest file was written
ID of the schema used to write the manifest file as a string
Table format version number of the manifest file as a string
Type of content files tracked by the manifest file: “data” or “deletes”
Type of content stored by the data file
File path
File format
Used to track additions and deletions.
Snapshot id where the file was added, or deleted
Data sequence number of the file
File sequence number indicating when the file was added
File path, and metrics for a data file as discussed further below

The compute service manager 104 creates a set of metadata files in a table format including, in this example, manifest file 308 and manifest file 309. As shown, each manifest file includes information indicating a set of data files stored in a particular file format and associated statistics or metrics of each data file in the external volume on storage platform 111. As further shown, each manifest file includes a reference (e.g., pointer) to a data file stored on the external volume. In an implementation, a given manifest file includes a list of paths corresponding to the set of data files. In addition, information related to a data file is also included in the manifest file, which can include column-level metrics such as upper and lower bounds of values from each column that can be utilized for pruning files during query compilation.

In an implementation, a manifest file is an immutable file (e.g., in Avro format, and the like) that lists data files or delete files, along with metrics, and tracking information. A set of manifest files is utilized to store a snapshot, which tracks all of the files in a table at some point in time. Manifest files are tracked by a manifest list for each snapshot of a table.

As further shown, the example of FIG. 3 includes a set of data files, including data file 310, data file 311, data file 312, and data file 313, that may be in a different file formats and are referenced by the aforementioned manifest files on the external volume and the EP files on internal storage discussed above. In some examples, the data files are immutable in that once written, they are changed by being deleted and replaced with another data file. In some examples, the data files are mutable in that changes may be made to them by making additions, deletions, and changes to the contents of the data file.

In an implementation, examples of metadata included in a data file can include the following:
Type of content stored by the data file: data, equality deletes, or position deletes
Full URI for the file
String file format name (e.g., Avro, ORC, Parquet, or the like)
Number of records in this file
Total file size in bytes
Map from column id to the total size on disk of all regions that store the column
Map from column id to number of values in the column (including null and NaN values)
Map from column id to number of null values in the column
Map from column id to number of NaN values in the column
Map from column id to number of distinct values in the column; distinct counts must be derived using values in the file by counting or using sketches, but not using methods like merging existing distinct counts
Map from column id to lower bound in the column serialized as binary
Map from column id to upper bound in the column serialized as binary
Implementation-specific key metadata for encryption
Split offsets for the data file. For example, all row group offsets in a data file.
Field ids used to determine row equality in equality delete files.
ID representing sort order for this file.
A minimum and maximum value in a data table of this file.

In an implementation, data files (e.g., data file 310, data file 311, data file 312, and data file 313) are referenced in a manifest file.

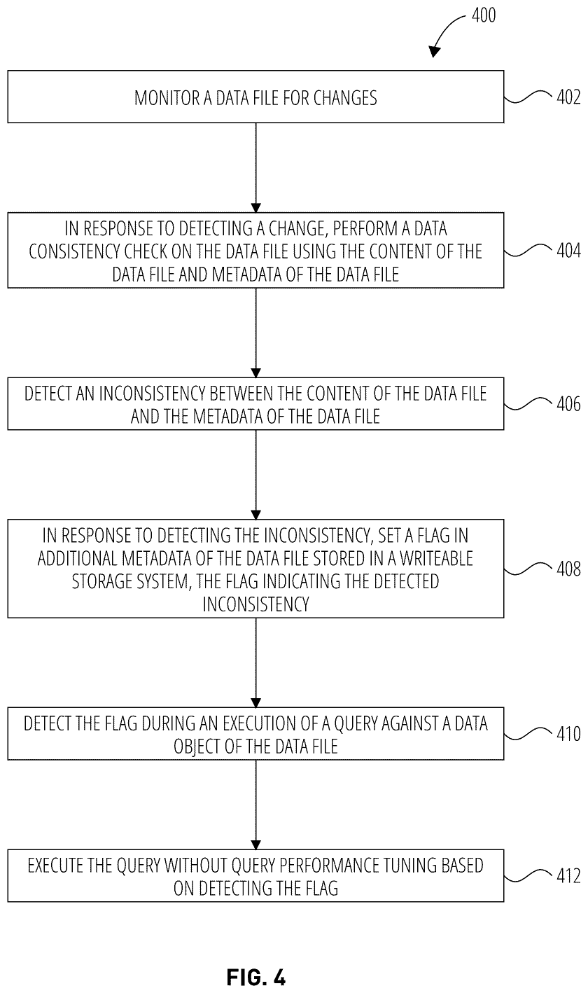

FIG. 4 illustrates an example consistency check method 400 for determining a consistency of a data file, according to some examples. The consistency check method 400 is used by a network-based database system 101 (of FIG. 1) to check the consistency between data files containing data used in data objects and metadata of the data file. Although the example consistency check method 400 depicts a particular sequence of operations, the sequence may be altered without departing from the scope of the present disclosure. For example, some of the operations depicted may be performed in parallel or in a different sequence that does not materially affect the function of the consistency check method 400. In other examples, different components of the network-based database system 101 that implement the consistency check method 400 may perform functions at substantially the same time or in a specific sequence.

In operation 402, the network-based database system 101 monitors a data file for changes. For example, the network-based database system 101 monitors a data file, such as data file 310 (of FIG. 3) of an external volume object 103 (of FIG. 3) for changes by implementing a file monitoring mechanism. This mechanism is designed to detect changes in the data files. In some examples, the data files are immutable in that once written, they are changed by being deleted and replaced with another data file. In some examples, the data files are mutable in that changes may be made to them by making additions, deletions, and modifications to the contents of the data files. The system utilizes event-driven or polling-based methods to continuously or periodically check the state of the data file 310. When a change is detected, the system logs the type of change and the specific parts of the file that were altered. This information is used for maintaining up-to-date data integrity and for triggering subsequent operations such as data consistency checks or updates to related metadata. In some examples, the monitoring process is optimized to minimize performance impact on the system while ensuring that all changes are captured accurately and in a timely manner.

In some examples, watermark methodologies for incremental checks are used. The methodologies provide for maintaining a marker or timestamp that represents the state of data at a specific point in time. This watermark is used to identify which data has been checked and which has not, allowing for efficient incremental checks without the need to re-examine data that has already been verified. When the data consistency check method 400 is executed, the network-based database system 101 scans all available data files and performs consistency checks. As the network-based database system 101 completes the checks, the network-based database system 101 records a watermark, which could be a timestamp or a logical identifier indicating the last file or data block checked. In later operations, the network-based database system 101 only scans files or data blocks that have been added or modified since the last recorded watermark. This means that only new or changed data is checked, reducing the amount of data that needs to be processed compared to a full scan. After each incremental check, the watermark is updated to reflect the latest state of the data that has been checked. This update ensures that any future checks continue from the correct point.

As an example, a data file may be changed daily. Each day, the data consistency network-based database system 101 checks only the files that have been added or modified since the last watermark, which is updated at the end of each day's check. This approach ensures that the network-based database system 101 does not waste resources re-checking unchanged data.

In another example, data is continuously streamed into the data file. The watermark is a high-water mark of the last data point checked. The network-based database system 101 periodically checks new data up to the latest point and updates the watermark accordingly. This method is particularly useful in environments with continuous data ingestion, like log analysis or real-time monitoring systems.

In another example, during a consistency check, an error occurs that interrupts the consistency check method 400. Once the error is resolved, the network-based database system 101 resumes the consistency check from the last successful watermark, ensuring no data is skipped and none is unnecessarily re-checked.

In some examples, the network-based database system 101 does not have write access to the data file being checked. This can arise because the network-based database system 101 does not have an appropriate database role needed for write access to the data file. For example, the network-based database system 101 may host provider users who provide database services to consumer users who consume or use the database services.

In some examples, a provider user may provide a database service that is an application that accesses a database object of the consumer user for read-only operations.

In some examples, a consumer user may have an application in the consumer user's account that is provided by a provider user. Although the application is in the consumer user's account, the consumer user may not want the application to have write access to the data file.

In some examples, a provider user may provide an application to a consumer user that the consumer user executes from the consumer user's account. The application may have read-only access to the provider user's data files.

In some examples, the proprietor of the network-based database system 101 may provide a generic service that maintains the consistency of all data files that are part of the network-based database system 101. Although the proprietor provides the service, the consumer users and provider users who own the data files may not want the proprietor to have write access to the data files.

In some examples, the data file, such as data file 310, is stored on a storage platform 111 that is external to the network-based database system 101. In some examples, the data file is stored in a storage platform that is a component (not shown) of the network-based database system 101.

In operation 404, the network-based database system 101, in response to detecting a change in a data file, performs a data consistency check on the data file using the content of the data file and metadata of the data file. For example, the network-based database system 101, upon detecting a change in a data file, initiates a data consistency check. This check involves comparing the current content of the data file, such as data file 310, against metadata associated with data file 310, such as manifest file 309 (of FIG. 3) that includes statistics (stats) of the command 301. The metadata includes information about the data file 310 as more fully described in reference to FIG. 3. The network-based database system 101 retrieves the metadata and the actual data, then systematically verifies each aspect of the metadata against the data file's content.

In some examples, the network-based database system 101 performs a Level 3 type consistency check is a comprehensive and detailed process designed to ensure data integrity across various layers of a database system. This type of check is particularly focused on verifying the consistency between the metadata and the actual data stored within the database.

The Level 3 consistency check operates by first identifying and analyzing the metadata associated with specific data files or data blocks. Metadata includes, but is not limited to, information such as data types, sizes, timestamps, checksums that describe the characteristics and state of the data, a minimum and a maximum value in data tables, and the like as more fully described in reference to FIG. 3. The network-based database system 101 then proceeds to systematically compare this metadata against the actual data content stored in the data file.

During the execution of a Level 3 check, the network-based database system 101 scans the data file to validate that the attributes recorded in the metadata accurately reflect the current state of the data in the data file. This includes, but is not limited to, verifying that the file sizes match, timestamps are updated correctly, and checksums confirm the data's integrity. If discrepancies are detected during these comparisons, it suggests issues such as data corruption, incomplete data writes, or unauthorized data modifications.

In some examples, to perform these checks, the network-based database system 101 may use algorithms that calculate checksums of the data files and compare them with the checksums stored in the metadata. In some examples, the network-based database system 101 also checks for data completeness by ensuring that all expected data blocks are present and correctly sequenced according to the metadata specifications.

In some examples, a consistency check includes checking the data files against a schema. For example, a schema inconsistency may occur when columns of a data table are missing or have inconsistent metadata for a minimum value, a maximum value, a number of distinct values, a null count, and the like, and/or are flagged as having invalid footer statistics.

If inconsistencies are found, the network-based database system 101 flags these issues in a writable storage location for use in correcting a query against a data object of the data file.

In some examples, actions are taken including logging the inconsistency for audit and troubleshooting purposes, alerting system administrators, and the like.

The Level 3 consistency check is useful for maintaining the reliability and accuracy of the data within the network-based database system 101, ensuring that the network-based database system 101 operates correctly and efficiently while safeguarding against data loss and corruption.

In some examples, the network-based database system 101 performs a Level 2 type consistency check. A Level 2 consistency check is a process aimed at ensuring the accuracy and integrity of EP metadata, such as EP file 304 (of FIG. 3) in relation to the database's underlying data layers. This check is more comprehensive than Level 1 checks but less intensive than Level 3 checks, focusing specifically on the alignment between EP metadata and the metadata stored with the data file.

The Level 2 consistency check begins by retrieving the EP metadata that includes, but is not limited to, detailed information about data expressions and properties that are used for optimizing query performance and data retrieval processes as more fully described in reference to FIG. 3. The network-based database system 101 then systematically compares this EP metadata against the metadata stored with the data file.

During this process, the system examines various aspects of the EP metadata and the file metadata to ensure they are in sync. This includes verifying that the metadata accurately reflects the data's structure, type, and other characteristics as defined in the database schema. The check also involves validating that the metadata's statistical information, such as min/max values and null counts, correctly represents the actual data distribution and characteristics.

If the Level 2 consistency check identifies discrepancies between the EP metadata and the metadata of the data files, the Level 2 consistency check indicates potential issues such as outdated metadata, errors in data processing, or issues in data storage that could affect data retrieval accuracy and performance. When inconsistencies are detected, the system takes actions such as flagging the discrepancies for use in further processes including, but not limited to: query planning; alerting database administrators; triggering automated processes to correct the metadata to reflect the true state of the data; and the like.

Level 2 consistency checks are useful for maintaining the operational efficiency of the database, ensuring that the metadata used for query performance tuning and data management is accurate and reliable. By regularly performing Level 2 consistency checks, the network-based database system 101 helps prevent data-related errors, helps catch bugs and/or regressions introduced into the system, and enhances the overall integrity and performance of the network-based database system 101.

In operation 406, if network-based database system 101 detects an inconsistency between the content of the data file and the first metadata then, in operation 408, the network-based database system 101 sets a flag in metadata stored on a writeable storage location of the network-based database system 101 where the flag indicates the detected inconsistency. For example, when the network-based database system 101 detects a mismatch between the content of the data file and the metadata, the network-based database system 101, this discrepancy is determined to be an inconsistency. Following the detection of an inconsistency, the network-based database system 101 proceeds to set a flag in additional metadata that is stored on a writable storage location within the network-based database system 101. This flag specifically indicates the presence of the detected inconsistency. The process of setting this flag involves updating the metadata record associated with the data file to include a marker or an indicator, such as a Boolean flag or a specific error code, which signifies that an inconsistency has been found. The flag serves multiple purposes including, but not limited to, indicating that the network-based database system 101 should not use the metadata stored in the read-only datastore for query performance tuning when formulating a query plan.

In some examples, a flag is an inconsistency flag: This flag is set when an inconsistency between the content of the data file and its metadata is detected. It indicates that there is a discrepancy that needs to be addressed to ensure accurate queries.

In some examples, an invalid EP Stats Flag is set. This flag is set when there is an inconsistency between the data file and the statistics itself, indicating that the internal representation of EP state is incorrect. This flag helps in making runtime decisions about data query performance tuning and query execution, ensuring that unreliable statistics do not affect the outcome of data queries.

In operation 410, the network-based database system 101 detects the flag during an execution of a query against a data object of the data file. For example, the network-based database system 101 detects the flag during the execution of a query against a data object of the data file. This detection process is integrated into the query execution workflow, where the network-based database system 101 checks for any flags in the metadata associated with the data files being queried. If a flag indicating an inconsistency is present, the network-based database system 101 identifies this before proceeding with data retrieval or processing. The detection of the flag influences how the query is handled. Depending on the configuration of the network-based database system 101 and the nature of the flag, the execution of a query plan may be adjusted to not use a query performance tuning that may rely on the metadata of the data file. In some examples, the network-based database system 101 bypass certain query performance tunings in the query plan that rely on the flagged metadata.

In operation 412, the network-based database system 101 executes the query without query performance tuning based on detecting the flag. For example, when the network-based database system 101 detects a flag indicating a discrepancy between the metadata and the actual data content, the network-based database system 101 adjusts a query execution strategy to bypass typical query performance tuning techniques that rely on the flagged metadata. This operation allows for maintaining the integrity and accuracy of the query results in the presence of identified inconsistencies in the metadata of the data file. When the system detects a flag indicating a discrepancy between the metadata and the actual data content, it adjusts the query execution strategy to bypass typical query performance tuning techniques that rely on the flagged metadata.

In some examples, executing the query without query performance tuning means that the network-based database system 101 might not use methods such as, but not limited to, index-based access, partition pruning, or other query performance tuning that could potentially lead to incorrect results due to the unreliable metadata. Instead, the network-based database system 101 opts for a more comprehensive scan of the data, ensuring that all relevant data is considered without presumptions based on possibly corrupted metadata. This approach, while potentially less efficient, prioritizes the correctness of the query result's accuracy and reliability, ensuring that the results of the query are based solely on the actual data present in the database, rather than on metadata that has been flagged as inconsistent. This methodology is useful in scenarios where data integrity is important, and helps prevent the propagation of errors in business intelligence, reporting, or any data-driven decision-making processes.

In some examples, the network-based database system 101 generates a report detailing the detected inconsistencies between the content of the data file and the first metadata. For example, this process is initiated once the system identifies discrepancies during its data consistency checks. The report includes comprehensive information about the nature of the inconsistencies, such as mismatches in file size, checksum errors, or timestamp discrepancies. The generation of this report involves collecting data about each detected inconsistency, including the specific type of mismatch, the affected data segments, and potentially the impact level of the inconsistency on the overall data integrity. The system then compiles this information into a structured report format that can be easily reviewed by system administrators or data managers. This report serves multiple purposes: it acts as a diagnostic tool that helps in pinpointing the sources of data errors, it provides a basis for corrective actions to resolve the data integrity issues, and it serves as a record for audit trails and compliance purposes. By documenting the inconsistencies, the system not only facilitates immediate remedial actions but also supports long-term data governance strategies by providing insights into the patterns and frequencies of data integrity issues. This proactive approach in reporting helps maintain the trustworthiness and reliability of the data stored within the network-based database system.

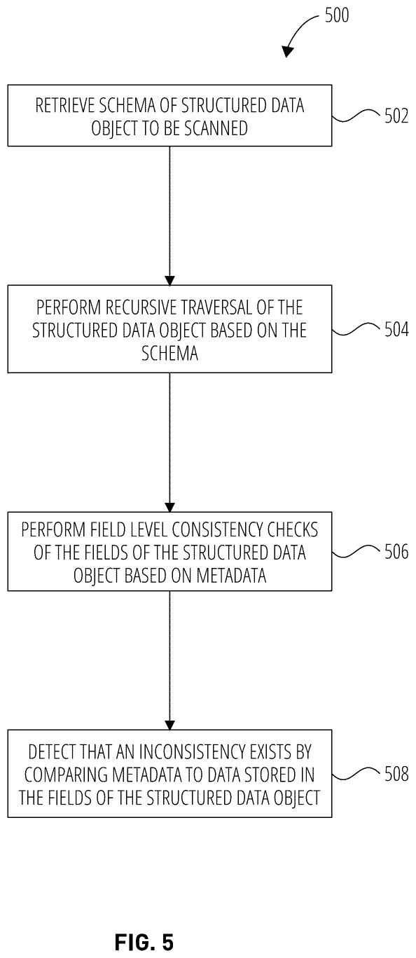

In some examples, the data file comprises structured data types, and the data consistency check includes validating each structured data type against corresponding metadata as more fully described in reference to FIG. 5.

In some examples, the data consistency check is performed periodically based on a predefined schedule. This systematic approach ensures that the data maintained within the network-based database system remains accurate and reliable over time. The scheduling of these checks is configured according to the specific needs and operational dynamics of the system, taking into account factors such as data volatility, system usage patterns, and criticality of the data. For example, a schedule is set within the management framework of the network-based database system 101. This schedules the frequency of the consistency checks, which can range from multiple times a day to weekly or monthly, depending on the system's requirements and the sensitivity of the data. The schedule is typically configured by system administrators who assess the risk and impact of data inconsistencies. Once the schedule is established, the network-based database system 101 automatically triggers the consistency checks at the specified intervals. During each scheduled check, the network-based database system 101 scans the data files and their associated metadata to identify any discrepancies or anomalies. The periodic nature of these checks helps in early detection of potential data issues, allowing for timely interventions to correct any identified problems. This proactive approach minimizes the risk of data errors propagating through the system and affecting downstream processes or decision-making based on inaccurate data. In some examples, the results of each periodic check are logged and can be reviewed by system administrators. This logging not only provides an audit trail of data integrity over time but also helps in identifying patterns or recurring issues that may require more comprehensive corrective actions or adjustments to the data handling and storage protocols within the network-based database system.

In some examples, the network-based database system 101 notifies a user via a user interface about the detected inconsistency and the setting of the flag. Following this notification, the network-based database system 101 provides the user with detailed information through the user interface, which includes the specific nature of the inconsistency, the data file affected, and the exact metadata values that were found to be inconsistent. This detailed report allows the user to understand the context and severity of the issue, facilitating informed decision-making regarding potential corrective actions.

For example, if the inconsistency involves a mismatch between the recorded file size in the metadata and the actual file size on disk, the user interface will display both the expected file size (from the metadata) and the measured file size (from the system's recent scan). Additionally, the interface might offer tools or options for the user to initiate a deeper diagnostic process or to revert to a previous, consistent version of the data file if available.

In some examples, a user is notified of metadata inconsistencies through an informational schema or monitoring schema view that indicates which columns of a data table of a data file are missing metadata such as a minimum value, a maximum value, a number of distinct values indication, a null count value count, or are flagged with an invalid footer statistics flag.

In some examples, a user is notified using a view that surfaces Level 3 inconsistencies to the user. Such a view specifically describes mismatches in file data vs file statistics.

In some examples, the network-based database system 101 also logs this interaction and the details of the inconsistency in an audit trail for compliance and future reference. This logging includes timestamps of the detection and notification events, user responses, and any system actions taken in response to the user's decisions. This comprehensive logging ensures transparency and traceability of data integrity issues within the system.

In some examples, the inconsistency flag is stored in a distributed metadata system that is accessible by multiple computing nodes performing queries against data objects of the data file. This distributed metadata system facilitates the synchronization and sharing of data integrity information across various components of the network-based database system. When an inconsistency flag is set, it is propagated across the distributed metadata system, ensuring that all computing nodes have up-to-date information regarding the status of data files they might access or query. For example, when a computing node initiates a query that involves a data file with a set inconsistency flag, the node can access the distributed metadata system to check the flag status before proceeding. If the flag indicates a data inconsistency, the node can adjust its query processing logic to either avoid using the affected data file or to handle the data with additional caution, such as by applying more stringent data validation rules or by excluding the flagged data from the results. The system ensures that the inconsistency flags are consistently and reliably updated in the distributed metadata system. This is achieved through a synchronization mechanism that propagates updates to all nodes in near real-time. In some examples, this mechanism uses a publish-subscribe model, where changes to the metadata, including the setting of inconsistency flags, are published by the node detecting the inconsistency, and all other nodes subscribe to these updates to maintain metadata consistency across the system. In some examples, the network-based database system 101 maintains a history of all flags set against each data file, including timestamps and details of the inconsistencies detected. This historical data can be used for auditing purposes, to analyze the frequency and types of data inconsistencies encountered, and to improve data handling strategies over time.

In some examples, the data file is maintained within a cloud-based storage environment, and the consistency check method 400 includes the communication of the inconsistency flag to a service dedicated to managing metadata within the same cloud infrastructure.

In some examples, the cloud-based storage system serves as the primary repository for data files, and upon detection of an inconsistency, the network-based database system 101 transmits a flag indicating this issue to a cloud-based metadata management service. This service is responsible for cataloging and monitoring the status of data across various storage locations within the cloud, ensuring that all access points to the data are aware of its current integrity status.

In some examples, when an inconsistency is detected, the system generates a flag that encapsulates details such as the type of inconsistency, the affected data file's identifier, and a timestamp. This flag is then transmitted using secure data transmission protocols to ensure data integrity and confidentiality. The cloud-based metadata management service, upon receiving the flag, updates its records to reflect the new data status. This update is propagated across all nodes that might access the data file, ensuring that any subsequent operations are aware of the potential data integrity issue. This service may utilize distributed ledger technology to maintain an immutable record of all flags and their associated data files, enhancing the traceability and auditability of data integrity checks.

In some examples, executing query by the network-based database system 101 without query performance tuning includes bypassing a query performance tuning engine configured to use the first metadata for optimizing query execution. For example, executing the query without query performance tuning involves circumventing standard procedures that enhance query performance based on pre-established metadata guidelines. In some examples, the network-based database system 101 bypasses a query performance tuning engine that typically utilizes the metadata stored with the data file to streamline and enhance the efficiency of query execution. This engine generally employs metadata to make decisions about data indexing, caching strategies, and the most efficient data retrieval paths. In more specific examples, when a flag indicating metadata inconsistency is detected, the system modifies its query execution pathway to exclude the use of the query performance tuning engine. This adjustment prevents the engine from relying on potentially corrupted metadata which could lead to inaccurate query results or further data handling errors. Instead, the query is processed in a more straightforward manner, which might be slower but ensures the accuracy and reliability of the results by directly interacting with the database without any presumptive shortcuts based on the flagged metadata. In some examples, bypassing query performance tuning includes scanning entire tables or datasets rather than using indexed or pre-filtered paths, ensuring that all data considered is current and uncorrupted.

In some examples, the network-based database system 101 determines an inconsistency has been resolved. In response to determining that the inconsistency has been resolved, the network-based database system 101 removes the flag from the metadata. For example, the network-based database system 101 identifies that a previously detected data inconsistency no longer exists. Following this determination, the network-based database system 101 proceeds to update its records by removing the previously set flag from the metadata. In some examples, the network-based database system 101 conducts a follow-up verification process to confirm that the issues leading to the inconsistency have been effectively resolved. Example processes include, but are not limited to, re-scanning the affected data file or re-validating the metadata against the actual data. Once the network-based database system 101 confirms that the data and its metadata are in alignment and the inconsistency has indeed been resolved, the network-based database system 101 removes the flag that had been set in the metadata to indicate the previous inconsistency.

In some examples, the process of removing the flag is handled through an update to the metadata storage system, ensuring that the change is accurately recorded and consistent across all nodes in the network-based database system 101. For example, such an update uses a timestamped log entry that records the removal of the flag, providing an audit trail that can be reviewed for compliance and historical analysis. In some examples, the network-based database system 101 triggers notifications to inform relevant stakeholders or systems that the data integrity has been restored, which can influence downstream processes or systems that rely on this data. This ensures that all components of the network-based database system 101 that interact with the affected data are aware of the resolution and can adjust their operations accordingly.

FIG. 5 illustrates a method for scanning structured data objects 500, according to some examples. A network-based database system 101 uses the method for scanning structured data objects 500 to scan a structured data object for a consistency check as more fully described in reference to FIG. 4. Although the method for scanning structured data objects 500 depicts a particular sequence of operations, the sequence may be altered without departing from the scope of the present disclosure. For example, some of the operations depicted may be performed in parallel or in a different sequence that does not materially affect the function of the routine. In other examples, different components of a network-based database system 101 (of FIG. 1) that implements the method for scanning structured data objects 500 may perform functions at substantially the same time or in a specific sequence.

In operation 502, the network-based database system 101 retrieves a schema of a structured data object to be scanned. This schema defines the structure, types, and relationships of the data fields within the structured data object. Understanding the schema guides the subsequent operations of the scanning process. For example, the network-based database system 101 initiates a process to access and interpret the structure of the data object to be scanned. This involves identifying and retrieving the organizational blueprint or schema that defines the layout and types of data contained within the data object. In some examples, the retrieval of the schema by the network-based database system 101 involves querying a metadata repository where schemas are stored and managed. The network-based database system 101 uses the identifier of the structured data object to fetch the corresponding schema, which details the fields, data types, and possibly relationships and constraints applicable to the data object. This schema is used for guiding subsequent operations on the data object, such as validation, querying, or data integrity checks.

In some examples, once the schema is retrieved, the network-based database system 101 parses this schema to construct a detailed understanding of each component of the structured data object. As an example, if the data object is a complex customer record, the schema may define various fields such as name, address, and transaction history, each with its own specific data type and structure (e.g., string, object, array). The network-based database system 101 then uses this parsed schema to dynamically generate a scanning strategy that respects the hierarchy and data types specified in the schema. In some examples, specific validation rules are specified for different fields based on their data type, such as checking string lengths or validating numerical ranges, and preparing to handle nested objects or arrays according to the relationships outlined in the schema. This detailed preparation provides that the scanning process is both thorough and efficient, tailored to the specific structure and requirements of the data object.

In operation 504, the network-based database system 101 performs a recursive traversal of the data object based on the schema. For example, the network-based database system 101 utilizes a methodical approach to explore and analyze the contents of a structured data object. This method involves systematically examining each component of the data structure from the topmost level down to its most detailed elements. In some examples, the network-based database system 101 implements a recursive traversal technique to navigate through the structured data object. This process starts at the root or the highest level of the data structure and progresses deeper into its nested levels. As the network-based database system 101 traverses the structure, the network-based database system 101 visits each node or field defined by the schema, ensuring that no part of the data object is overlooked.

In some examples, during the recursive traversal, the network-based database system 101 examines each node according to the rules and relationships outlined in the schema. For instance, if the structured data object is a complex JSON object representing a product catalog, the network-based database system 101 starts at the general product category level and then delves into individual products, each with attributes like price, description, and specifications. At each node, specific checks and operations are performed based on the node's data type and the schema's constraints. For example, string fields might be checked for proper formatting and length, numerical fields might be validated against range constraints, and object fields might trigger further recursive checks into their subfields. This detailed and schema-aware traversal ensures comprehensive validation and analysis of the structured data object, tailored to its specific configuration and hierarchy.

According to some examples, the method includes performing field level checks of the fields of the data object at operation 506. For example, as each field within the structured data object is accessed, the system performs specific checks based on the field's data type and defined constraints. For primitive data types (e.g., integers, strings), the system checks for data integrity and validity against the metadata. For complex types (e.g., nested objects, arrays), the system recursively applies appropriate checks to each sub-element. In some examples, for fields that contain complex data types, such as nested objects or arrays, the network-based database system 101 applies a recursive approach to validation. This means that each sub-element within a complex data type is individually assessed with the same rigor as the top-level elements. For instance, if a field contains an array of objects, each object in the array is checked to ensure it meets the same standards of data integrity and validity as the parent object. This recursive validation process helps in identifying and rectifying data inconsistencies not only at the surface level but also deep within the data structure, thereby enhancing the overall reliability of the data within the structured data object.

In operation 508, the network-based database system 101 detects that an inconsistency exists by comparing metadata to data stored in the fields of the structured data object. For each field, the network-based database system 101 retrieves and compares metadata that describes expected properties of the data stored in the data object to the data actually stored in the data object. The metadata may include, but is not limited to, data length, nullability, and the like. This metadata comparison is used to detect discrepancies that indicate inconsistencies between the data of the data object and the metadata. For example, the network-based database system 101 detects that an inconsistency exists by comparing metadata to data stored in the fields of the data object. This initial detection is useful for maintaining the integrity of the data within the system.

In some examples, the detection process involves retrieving metadata that outlines expected data characteristics such as type, format, and permissible values. The network-based database system 101 then compares this metadata against the actual data stored in the fields of the data object, looking for discrepancies that may indicate issues such as data corruption or unauthorized modifications.

In additional examples, the comparison is tailored to various data types and structures within the database. For instance, if the metadata specifies that a field should contain numeric data within a certain range, but the actual data includes a value outside this range, the system flags this as an inconsistency. This level of detail ensures that each field is checked according to its specific metadata definition, enhancing the reliability of the data management process.

In an example, a structured data object representing a person, which includes nested objects for address and contact information, may be represented by:

{
“name”: “John Doe”,
“age”: 30,
“address”: { “street”: “123 Elm St”, “city”: “Metropolis” },
“contacts”: [
{“type”: “home”, “number”: “123-456-7890”},
{“type”: “work”, “number”: “987-654-3210”}
]
}

The network-based database system 101 starts at the top level, checking the name and age fields for type correctness and constraints like non-null values and compares these statistics to statistics stored in the metadata for the data file. The network-based database system 101 then recursively moves to the address data object, checking each field within, and similarly for each object in the contacts array. Each operation involves validation against the schema and metadata, ensuring comprehensive coverage of the entire data structure.

This structured approach ensures that all components of complex data objects are validated systematically, maintaining high data integrity and reliability within the network-based database system.

In some examples, if inconsistencies or errors are detected during the scan, the network-based database system 101 logs these issues with detailed information about the location within the structured data object and the nature of the inconsistency. This information is compiled into a report that can be used for further analysis and corrective actions.

In some examples, after the complete structured data object has been scanned, the system aggregates the results to provide a comprehensive overview of the data integrity across the entire object. This aggregation helps in understanding the overall health of the structured data and in making informed decisions about data management.

FIG. 6 is a block diagram illustrating components of the execution platform 107, according to some examples. As shown in FIG. 6, the execution platform 107 includes multiple virtual warehouses, including virtual warehouse 602a, and virtual warehouse 602b to virtual warehouse 602c. Each virtual warehouse includes multiple execution nodes that each includes a data cache and a processor. The virtual warehouses can execute multiple tasks in parallel by using the multiple execution nodes. As discussed herein, the execution platform 107 can add new virtual warehouses and drop existing virtual warehouses in real time based on the current processing needs of the systems and users. This flexibility allows the execution platform 107 to quickly deploy large amounts of computing resources when needed without being forced to continue paying for those computing resources when they are no longer needed. Virtual warehouses can access data from any data storage device (e.g., any storage device in storage platform 111).

Although each virtual warehouse shown in FIG. 6 includes three execution nodes, a particular virtual warehouse may include any number of execution nodes. Further, the number of execution nodes in a virtual warehouse is dynamic, such that new execution nodes are created when additional demand is present, and existing execution nodes are deleted when they are no longer necessary.

Each virtual warehouse is capable of accessing any of the data storage devices 112-1 to 112-N shown in FIG. 1. Thus, the virtual warehouses are not necessarily assigned to a specific data storage device 1 to N and, instead, can access data from any of the data storage devices 1 to N within the storage platform 111. Similarly, each of the execution nodes shown in FIG. 6 can access data from any of the data storage devices 112-1 to 112-N. In some examples, a particular virtual warehouse or a particular execution node may be temporarily assigned to a specific data storage device, but the virtual warehouse or execution node may later access data from any other data storage device.

In the example of FIG. 6, virtual warehouse 602a includes a plurality of execution nodes as exemplified by execution node 604a, execution node 604b, and execution node 604c. Execution node 604a includes cache 606a and a processor 608a. Execution node 604b includes cache 606b and processor 608b. Execution node 604c includes cache 606c and processor 608c. Each execution node 1 to N is associated with processing one or more data storage and/or data retrieval tasks. For example, a virtual warehouse may handle data storage and data retrieval tasks associated with an internal service, such as a clustering service, a materialized view refresh service, a file compaction service, a storage procedure service, or a file upgrade service. In other implementations, a particular virtual warehouse may handle data storage and data retrieval tasks associated with a particular data storage system or a particular category of data.

Similar to virtual warehouse 602a discussed above, virtual warehouse 602b includes a plurality of execution nodes as exemplified by execution node 610a, execution node 610b, and execution node 610c. Execution node 604a includes cache 612a and processor 614a. Execution node 610b includes cache 612b and processor 614b. Execution node 610c includes cache 612c and processor 614c. Additionally, virtual warehouse 602c includes a plurality of execution nodes as exemplified by execution node 616a, execution node 616b, and execution node 616c. Execution node 616a includes cache 618a and processor 620a. Execution node 616b includes cache 618b and processor 620b. Execution node 616c includes cache 618c and processor 620c.

In some examples, the execution nodes shown in FIG. 6 are stateless with respect to the data the execution nodes are caching. For example, these execution nodes do not store or otherwise maintain state information about the execution node or the data being cached by a particular execution node. Thus, in the event of an execution node failure, the failed node can be transparently replaced by another node. Since there is no state information associated with the failed execution node, the new (replacement) execution node can easily replace the failed node without concern for recreating a particular state.

Although the execution nodes shown in FIG. 6 each include one data cache and one processor, alternate examples may include execution nodes containing any number of processors and any number of caches. Additionally, the caches may vary in size among the different execution nodes. The caches shown in FIG. 6 store, in the local execution node, data that was retrieved from one or more data storage devices in storage platform 111. Thus, the caches reduce or eliminate the bottleneck problems occurring in platforms that consistently retrieve data from remote storage systems. Instead of repeatedly accessing data from the remote storage devices, the systems and methods described herein access data from the caches in the execution nodes, which is significantly faster and avoids the bottleneck problem discussed above. In some examples, the caches are implemented using high-speed memory devices that provide fast access to the cached data. Each cache can store data from any of the storage devices in the storage platform 111.

Further, the cache resources and computing resources may vary between different execution nodes. For example, one execution node may contain significant computing resources and minimal cache resources, making the execution node useful for tasks that require significant computing resources. Another execution node may contain significant cache resources and minimal computing resources, making this execution node useful for tasks that require caching of large amounts of data. Yet another execution node may contain cache resources providing faster input-output operations, useful for tasks that require fast scanning of large amounts of data. In some examples, the cache resources and computing resources associated with a particular execution node are determined when the execution node is created, based on the expected tasks to be performed by the execution node.

Additionally, the cache resources and computing resources associated with a particular execution node may change over time based on changing tasks performed by the execution node. For example, an execution node may be assigned more processing resources if the tasks performed by the execution node become more processor-intensive. Similarly, an execution node may be assigned more cache resources if the tasks performed by the execution node require a larger cache capacity.

Although virtual warehouses 1, 2, and N are associated with the same execution platform 107, the virtual warehouses may be implemented using multiple computing systems at multiple geographic locations. For example, virtual warehouse 1 can be implemented by a computing system at a first geographic location, while virtual warehouses 2 and N are implemented by another computing system at a second geographic location. In some examples, these different computing systems are cloud-based computing systems maintained by one or more different entities.

Additionally, each virtual warehouse as shown in FIG. 6 has multiple execution nodes. The multiple execution nodes associated with each virtual warehouse may be implemented using multiple computing systems at multiple geographic locations. For example, an instance of virtual warehouse 602a implements execution node 604a and execution node 604b on one computing platform at a geographic location and implements execution node 604c at a different computing platform at another geographic location. Selecting particular computing systems to implement an execution node may depend on various factors, such as the level of resources needed for a particular execution node (e.g., processing resource requirements and cache requirements), the resources available at particular computing systems, communication capabilities of networks within a geographic location or between geographic locations, and which computing systems are already implementing other execution nodes in the virtual warehouse.

A particular execution platform 107 may include any number of virtual warehouses. Additionally, the number of virtual warehouses in a particular execution platform is dynamic, such that new virtual warehouses are created when additional processing and/or caching resources are needed. Similarly, existing virtual warehouses may be deleted when the resources associated with the virtual warehouse are no longer necessary.

In some examples, the virtual warehouses may operate on the same data in storage platform 111, but each virtual warehouse has its own execution nodes with independent processing and caching resources. This configuration allows requests on different virtual warehouses to be processed independently and with no interference between the requests. This independent processing, combined with the ability to dynamically add and remove virtual warehouses, supports the addition of new processing capacity for new users without impacting the performance observed by the existing users.

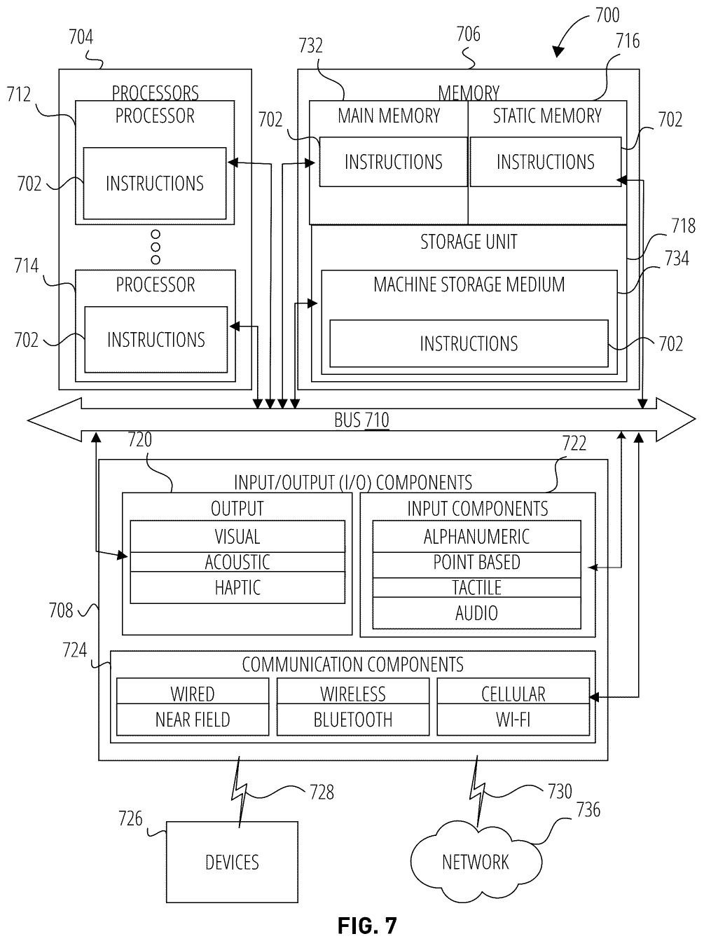

FIG. 7 illustrates a diagrammatic representation of a machine 700 in the form of a computer system within which a set of instructions may be executed for causing the machine 700 to perform any one or more of the methodologies discussed herein, according to examples. Specifically, FIG. 7 shows a diagrammatic representation of the machine 700 in the example form of a computer system, within which instructions 702 (e.g., software, a program, an application, an applet, an application, or other executable code) for causing the machine 700 to perform any one or more of the methodologies discussed herein may be executed. For example, the instructions 702 may cause the machine 700 to execute any one or more operations of any one or more of the methods described herein. In this way, the instructions 702 transform a general, non-programmed machine into a particular machine 700 (e.g., the cloud storage provider system 102, the execution platform 107, and the data storage devices 112-1 to 112-N of storage platform 111) that is specially configured to carry out any one of the described and illustrated functions in the manner described herein.

In alternative examples, the machine 700 operates as a standalone device or may be coupled (e.g., networked) to other machines. In a networked deployment, the machine 700 may operate in the capacity of a server machine or a client machine in a server-client network environment, or as a peer machine in a peer-to-peer (or distributed) network environment. The machine 700 may comprise, but not be limited to, a server computer, a client computer, a personal computer (PC), a tablet computer, a laptop computer, a netbook, a smart phone, a mobile device, a network router, a network switch, a network bridge, or any machine capable of executing the instructions 702, sequentially or otherwise, that specify actions to be taken by the machine 700. Further, while only a single machine 700 is illustrated, the term “machine” shall also be taken to include a collection of machines that individually or jointly execute the instructions 702 to perform any one or more of the methodologies discussed herein.

The machine 700 includes hardware processors 704, memory 706, and I/O components 708 configured to communicate with each other such as via a bus 710. In some examples, the processors 704 (e.g., a central processing unit (CPU), a reduced instruction set computing (RISC) processor, a complex instruction set computing (CISC) processor, a graphics processing unit (GPU), a digital signal processor (DSP), an application-specific integrated circuit (ASIC), a radio-frequency integrated circuit (RFIC), another processor, or any suitable combination thereof) may include, for example, multiple processors as exemplified by processor 712 and a processor 714 that may execute the instructions 702. The term “processor” is intended to include multi-core processors that may comprise two or more independent processors (sometimes referred to as “cores”) that may execute instructions 702 contemporaneously. Although FIG. 7 shows multiple processors 704, the machine 700 may include a single processor with a single core, a single processor with multiple cores (e.g., a multi-core processor), multiple processors with a single core, multiple processors with multiple cores, or any combination thereof.

The memory 706 may include a main memory 732, a static memory 716, and a storage unit 718 including a machine storage medium 734, accessible to the processors 704 such as via the bus 710. The main memory 732, the static memory 716, and the storage unit 718 store the instructions 702 embodying any one or more of the methodologies or functions described herein. The instructions 702 may also reside, completely or partially, within the main memory 732, within the static memory 716, within the storage unit 718, within at least one of the processors 704 (e.g., within the processor's cache memory), or any suitable combination thereof, during execution thereof by the machine 700.

The input/output (I/O) components 708 include components to receive input, provide output, produce output, transmit information, exchange information, capture measurements, and so on. The specific I/O components 708 that are included in a particular machine 700 will depend on the type of machine. For example, portable machines such as mobile phones will likely include a touch input device or other such input mechanisms, while a headless server machine will likely not include such a touch input device. It will be appreciated that the I/O components 708 may include many other components that are not shown in FIG. 7. The I/O components 708 are grouped according to functionality merely for simplifying the following discussion and the grouping is in no way limiting. In various examples, the I/O components 708 may include output components 720 and input components 722. The output components 720 may include visual components (e.g., a display such as a plasma display panel (PDP), a light emitting diode (LED) display, a liquid crystal display (LCD), a projector, or a cathode ray tube (CRT)), acoustic components (e.g., speakers), other signal generators, and so forth. The input components 722 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

Communication may be implemented using a wide variety of technologies. The I/O components 708 may include communication components 724 operable to couple the machine 700 to a network 736 or devices 726 via a coupling 730 and a coupling 728, respectively. For example, the communication components 724 may include a network interface component or another suitable device to interface with the network 736. In further examples, the communication components 724 may include wired communication components, wireless communication components, cellular communication components, and other communication components to provide communication via other modalities. The devices 726 may be another machine or any of a wide variety of peripheral devices (e.g., a peripheral device coupled via a universal serial bus (USB)). For example, as noted above, the machine 700 may correspond to any one of the compute service manager 104, the execution platform 107, and the devices 726 may include the storage platform 111 or any other computing device described herein as being in communication with the network-based database system 101 or the storage platform 111.

The various memories (e.g., 706, 716, 732, and/or memory of the processor(s) 704 and/or the storage unit 718) may store one or more sets of instructions 702 and data structures (e.g., software) embodying or utilized by any one or more of the methodologies or functions described herein. These instructions 702, when executed by the processor(s) 704, cause various operations to implement the disclosed examples.

Described implementations of the subject matter can include one or more features, alone or in combination as illustrated below by way of example:
As used herein, the terms “machine-storage medium,” “device-storage medium,” and “computer-storage medium” mean the same thing and may be used interchangeably in this disclosure. The terms refer to a single or multiple storage devices and/or media (e.g., a centralized or distributed database, and/or associated caches and servers) that store executable instructions and/or data. The terms shall accordingly be taken to include, but not be limited to, solid-state memories, and optical and magnetic media, including memory internal or external to processors. Specific examples of machine-storage media, computer-storage media, and/or device-storage media include non-volatile memory, including by way of example semiconductor memory devices, e.g., erasable programmable read-only memory (EPROM), electrically erasable programmable read-only memory (EEPROM), field-programmable gate arrays (FPGAs), and flash memory devices; magnetic disks such as internal hard disks and removable disks; magneto-optical disks; and CD-ROM and DVD-ROM disks. The terms “machine-storage media,” “computer-storage media,” and “device-storage media” specifically exclude carrier waves, modulated data signals, and other such media, at least some of which are covered under the term “signal medium” discussed below.

In various examples, one or more portions of the network 736 may be an ad hoc network, an intranet, an extranet, a virtual private network (VPN), a local-area network (LAN), a wireless LAN (WLAN), a wide-area network (WAN), a wireless WAN (WWAN), a metropolitan-area network (MAN), the Internet, a portion of the Internet, a portion of the public switched telephone network (PSTN), a plain old telephone service (POTS) network, a cellular telephone network, a wireless network, a Wi-Fi® network, another type of network, or a combination of two or more such networks. For example, the network 736 or a portion of the network 736 may include a wireless or cellular network, and the coupling 730 may be a Code Division Multiple Access (CDMA) connection, a Global System for Mobile communications (GSM) connection, or another type of cellular or wireless coupling. In this example, the coupling 730 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, fifth generation wireless (5G) networks, Universal Mobile Telecommunications System (UMTS), High-Speed Packet Access (HSPA), Worldwide Interoperability for Microwave Access (WiMAX), Long Term Evolution (LTE) standard, others defined by various standard-setting organizations, other long-range protocols, or other data transfer technology.

The instructions 702 may be transmitted or received over the network 736 using a transmission medium via a network interface device (e.g., a network interface component included in the communication components 724) and utilizing any one of a number of well-known transfer protocols (e.g., hypertext transfer protocol (HTTP)). Similarly, the instructions 702 may be transmitted or received using a transmission medium via the coupling 728 (e.g., a peer-to-peer coupling) to the devices 726. The terms “transmission medium” and “signal medium” mean the same thing and may be used interchangeably in this disclosure. The terms “transmission medium” and “signal medium” shall be taken to include any intangible medium that is capable of storing, encoding, or carrying the instructions 702 for execution by the machine 700, and include digital or analog communications signals or other intangible media to facilitate communication of such software. Hence, the terms “transmission medium” and “signal medium” shall be taken to include any form of modulated data signal, carrier wave, and so forth. The term “modulated data signal” means a signal that has one or more of its characteristics set or changed in such a manner as to encode information in the signal.

The various operations of example methods described herein may be performed, at least partially, by one or more processors that are temporarily configured (e.g., by software) or permanently configured to perform the relevant operations. Similarly, the methods described herein may be at least partially processor-implemented. For example, at least some of the operations of the methodologies disclosed herein may be performed by one or more processors. The performance of certain of the operations may be distributed among the one or more processors, not only residing within a single machine, but also deployed across a number of machines. In some examples, the processor or processors may be located in a single location (e.g., within a home environment, an office environment, or a server farm), while in other examples the processors may be distributed across a number of locations.

Described implementations of the subject matter can include one or more features, alone or in combination as illustrated below by way of example.

Example 1 is a machine-implemented method, comprising: monitoring a data file for changes, the data file stored in a read only storage system; in response to detecting a change, performing a data consistency check on the data file using the content of the data file and first metadata of the data file; detecting an inconsistency between the content of the data file and the first metadata; in response to detecting the inconsistency, setting a flag in second metadata of the data file, the second metadata stored in a writeable storage system, the flag indicating the detected inconsistency; detecting the flag during an execution of a query against a data object of the data file; and executing the query without query performance tuning based on detecting the flag.

In Example 2, the subject matter of Example 1 includes, generating a report detailing the detected inconsistencies between the content of the data file and the first metadata.

In Example 3, the subject matter of any of Examples 1-2 includes, wherein the data file comprises structured data types, and the data consistency check includes validating each structured data type against corresponding metadata.

In Example 4, the subject matter of any of Examples 1-3 includes, wherein the data consistency check is performed periodically based on a predefined schedule.

In Example 5, the subject matter of any of Examples 1-4 includes, notifying a user via a user interface about the detected inconsistency and the setting of the flag.

In Example 6, the subject matter of any of Examples 1-5 includes, wherein the flag is stored in a distributed metadata system that is accessible by multiple computing nodes performing queries against the data file.

In Example 7, the subject matter of any of Examples 1-6 includes, wherein the data file is stored in a cloud-based storage system, and the operations further comprise transmitting the flag to a cloud-based metadata management service.

In Example 8, the subject matter of any of Examples 1-7 includes, logging the detected inconsistency in an audit log for compliance and monitoring purposes.

In Example 9, the subject matter of any of Examples 1-8 includes, wherein executing the query without query performance tuning includes bypassing a query performance tuning engine configured to use the first metadata for modifying a query plan.

In Example 10, the subject matter of any of Examples 1-9 includes, determining the inconsistency has been resolved; and in response to determining that the inconsistency has been resolved, and removing the flag from the second metadata.

Example 11 is at least one machine-readable medium including instructions that, when executed by processing circuitry, cause the processing circuitry to perform operations to implement any of Examples 1-10.

Example 12 is an apparatus comprising means to implement any of Examples 1-10.

Example 13 is a system to implement any of Examples 1-10.

Although the methodologies of the present disclosure have been described with reference to specific examples, it will be evident that various modifications and changes may be made to these examples without departing from the broader scope of the inventive subject matter. Accordingly, the specification and drawings are to be regarded in an illustrative rather than a restrictive sense. The accompanying drawings that form a part hereof show, by way of illustration, and not of limitation, specific examples in which the subject matter may be practiced. The examples illustrated are described in sufficient detail to enable those skilled in the art to practice the teachings disclosed herein. Other examples may be used and derived therefrom, such that structural and logical substitutions and changes may be made without departing from the scope of this disclosure. This Detailed Description, therefore, is not to be taken in a limiting sense, and the scope of various examples is defined only by the appended claims, along with the full range of equivalents to which such claims are entitled.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended; that is, a system, device, article, or process that includes elements in addition to those listed after such a term in a claim is still deemed to fall within the scope of that claim.

Such examples of the inventive subject matter may be referred to herein, individually and/or collectively, by the term “example” merely for convenience and without intending to voluntarily limit the scope of this application to any single invention or inventive concept if more than one is in fact disclosed. Thus, although specific examples have been illustrated and described herein, it should be appreciated that any arrangement calculated to achieve the same purpose may be substituted for the specific examples shown. This disclosure is intended to cover any and all adaptations or variations of various examples. Combinations of the above examples, and other examples not specifically described herein, will be apparent to those of skill in the art, upon reviewing the above description.

What is claimed is:

1. A machine-implemented method, comprising:
monitoring a data file for changes, the data file stored in a read only storage system;
in response to detecting a change, performing a data consistency check on the data file using a content of the data file and first metadata of the data file;
detecting an inconsistency between the content of the data file and the first metadata;
in response to detecting the inconsistency, setting a flag in second metadata of the data file, the second metadata stored in a writeable storage system, the flag indicating the detected inconsistency;
detecting the flag during an execution of a query against a data object of the data file; and
executing the query without query performance tuning based on detecting the flag.

2. The machine-implemented method of claim 1, further comprising generating a report detailing the detected inconsistencies between the content of the data file and the first metadata.

3. The machine-implemented method of claim 1, wherein the data file comprises structured data types, and the data consistency check includes validating each structured data type against corresponding metadata.

4. The machine-implemented method of claim 1, wherein the data consistency check is performed periodically based on a predefined schedule.

5. The machine-implemented method of claim 1, further comprising notifying a user via a user interface about the detected inconsistency and the setting of the flag.

6. The machine-implemented method of claim 1, wherein the flag is stored in a distributed metadata system that is accessible by multiple computing nodes performing queries against the data file.

7. The machine-implemented method of claim 1, wherein the data file is stored in a cloud-based storage system, and the machine-implemented method further comprises transmitting the flag to a cloud-based metadata management service.

8. The machine-implemented method of claim 1, further comprising logging the detected inconsistency in an audit log for compliance and monitoring purposes.

9. The machine-implemented method of claim 1, wherein executing the query without query performance tuning includes bypassing a query performance tuning engine configured to use the first metadata for modifying a query plan.

10. The machine-implemented method of claim 1, further comprising:
determining the inconsistency has been resolved; and
in response to determining that the inconsistency has been resolved, and removing the flag from the second metadata.

11. A system comprising:
at least one processor; and
at least one memory storing instructions that, when executed by the at least one processor, cause the system to perform operations comprising:
monitoring a data file for changes, the data file stored in a read only storage system;
in response to detecting a change, performing a data consistency check on the data file using a content of the data file and first metadata of the data file;
detecting an inconsistency between the content of the data file and the first metadata;
in response to detecting the inconsistency, setting a flag in second metadata of the data file, the second metadata stored in a writeable storage system, the flag indicating the detected inconsistency;
detecting the flag during an execution of a query against a data object of the data file; and
executing the query without query performance tuning based on detecting the flag.

12. The system of claim 11, wherein the operations further comprise generating a report detailing the detected inconsistencies between the content of the data file and the first metadata.

13. The system of claim 11, wherein the data file comprises structured data types, and the data consistency check includes validating each structured data type against corresponding metadata.

14. The system of claim 11, wherein the data consistency check is performed periodically based on a predefined schedule.

15. The system of claim 11, wherein the operations further comprise notifying a user via a user interface about the detected inconsistency and the setting of the flag.

16. The system of claim 11, wherein the flag is stored in a distributed metadata system that is accessible by multiple computing nodes performing queries against the data file.

17. The system of claim 11, wherein the data file is stored in a cloud-based storage system, and the operations further comprise transmitting the flag to a cloud-based metadata management service.

18. The system of claim 11, wherein the operations further comprise logging the detected inconsistency in an audit log for compliance and monitoring purposes.

19. The system of claim 11, wherein executing the query without query performance tuning includes bypassing a query performance tuning engine configured to use the first metadata for modifying a query plan.

20. The system of claim 11, wherein the operations further comprise:
determining the inconsistency has been resolved; and
in response to determining that the inconsistency has been resolved, and removing the flag from the second metadata.

21. A machine-storage medium storing instructions that, when executed by one or more processors of a system, cause the system to perform operations comprising:
monitoring a data file for changes, the data file stored in a read only storage system;
in response to detecting a change, performing a data consistency check on the data file using a content of the data file and first metadata of the data file;
detecting an inconsistency between the content of the data file and the first metadata;
in response to detecting the inconsistency, setting a flag in second metadata of the data file, the second metadata stored in a writeable storage system, the flag indicating the detected inconsistency;
detecting the flag during an execution of a query against a data object of the data file; and
executing the query without query performance tuning based on detecting the flag.

22. The machine-storage medium of claim 21, wherein the operations further comprise generating a report detailing the detected inconsistencies between the content of the data file and the first metadata.

23. The machine-storage medium of claim 21, wherein the data file comprises structured data types, and the data consistency check includes validating each structured data type against corresponding metadata.

24. The machine-storage medium of claim 21, wherein the data consistency check is performed periodically based on a predefined schedule.

25. The machine-storage medium of claim 21, wherein the operations further comprise notifying a user via a user interface about the detected inconsistency and the setting of the flag.

26. The machine-storage medium of claim 21, wherein the flag is stored in a distributed metadata system that is accessible by multiple computing nodes performing queries against the data file.

27. The machine-storage medium of claim 21, wherein the data file is stored in a cloud-based storage system, and the operations further comprise transmitting the flag to a cloud-based metadata management service.

28. The machine-storage medium of claim 21, wherein the operations further comprise logging the detected inconsistency in an audit log for compliance and monitoring purposes.

29. The machine-storage medium of claim 21, wherein executing the query without query performance tuning includes bypassing a query performance tuning engine configured to use the first metadata for modifying a query plan.

30. The machine-storage medium of claim 21, wherein the operations further comprise:
determining the inconsistency has been resolved; and
in response to determining that the inconsistency has been resolved, and removing the flag from the second metadata.
